(19) United States
(12) Patent Application Publication
(10) Pub. No.: US 2007/0234764 A1
(43) Pub. Date: Oct. 11, 2007

(54) Hasps, Shackles and Padlocks

(76) Inventor: Yoav Weinberger, Haifa (IL)

Correspondence Address: PEARL COHEN ZEDEK LATZER, LLP, 1500 BROADWAY 12TH FLOOR, NEW YORK, NY, 10036, US

(21) Appl. No.: 11/578,025

(22) PCT Filed:
(86) PCT No.: PCT/IL05/00387

(30) Foreign Application Priority Data
Apr. 14, 2004 (IL) 161368
Nov. 3, 2004 (IL) 165015
Jan. 10, 2005 (IL) 166228

(51) Int. Cl. E05B 65/48

(52) U.S. Cl. 70/2

(57) ABSTRACT

A locking device for cooperation with a separate shackle-less padlock for locking two separate adjacent objects or immobilizing relative movement between the objects. The device comprises a hasp assembly comprising at least one hasp element for securing to at least one of the objects, provided with at least one integral shackle pin designed to be engaged in a locked position with the padlock, so that the padlock serves to prevent disengagement of the objects or to immobilize relative motion between the objects Other embodiments are presented where the hasp assembly is provided with an integral locking mechanism.

### FIELD OF THE INVENTION

The present invention relates to locking apparatus generally and more particularly to one or more hasps, shackles and padlocks used for locking one or more swinging or sliding doors, gates, blinds, or other objects.

### BACKGROUND OF THE INVENTION

Hasps and padlocks are used as locking solutions for fastening doors and similar objects, such as gates. Examples of objects that can be locked by such solutions include a door to a doorway, two swinging or sliding doors to each other, window blinds to the window frame, container doors to the container wall, and so forth.

In these applications the hasp is implemented in sections. At least one section is mounted on each object to be locked. For example, one part of a hasp could be mounted on a door and the other part on the adjacent part of the doorway. Mounting means can be screws, rivets, welds, and other fastening methods. An example of a prior art hasp and padlock are shown in FIG. 1 and comprise first hasp section 20, second hasp section 22, shackle 24, lock 26, and mounting holes 28.

Each hasp section has at least one channel through which a shackle can be passed. The shackle comprises depending legs, with each leg passing through a different hasp section and a lock attached to the ends of the legs to complete the locking of the objects.

Prior art hasps are not appropriate for all needs, particularly applications where objects slide parallel to one another or swing adjacent to one another.

It would be desirable to provide a hasp that can accommodate various applications involving objects that slide parallel, or swing adjacently, to one another.

In addition to connecting a shackle and lock to an object, a hasp can also protect the shackle and lock. Such protective hasps are comprised of sturdy material, such as stainless steel, and provide recesses in which most or all of the shackle and lock are protected by the hasp. FIG. 2A is an exploded view of a prior art protective hasp. FIG. 2B is an exploded view of a prior art protective hasp further illustrating a recess 30 for the hasp and a recess 32 for the lock. FIG. 2C is a view of a locked prior art protective hasp and padlock showing the recessed hasp 24 and padlock 26.

An example of a prior art protective hasp as described above is disclosed in U.S. Pat. No. 4,548,058, awarded to Bahry, et al, (1985) and entitled “Protective Hasps for a Padlock”.

Prior art protective hasps can be difficult to use. The design makes it difficult to insert and remove the shackle. Also the shackle can be lost when not in use. Also, the lock can only be installed from the bottom. Also, only one lock can be used at a time. Also, the design of the mating shackle sections, while contributing to the vertical locking strength, does not contribute to the lateral locking strength. Also no means are provided for storing the lock when not in use.

It would be desirable to provide a protective hasp where the shackle element is integrated into the hasp sections, lock, or both. This would eliminate problems related to inserting and removing the shackle and related to keeping track of the shackle when not in use.

It would also be desirable to enable insertion of the lock from another direction besides the bottom of the shackle sections or insertion of multiple locks.

It would also be desirable for the mating surfaces of the shackle sections to contribute to the lateral locking strength.

It would also be desirable to provide a protective hasp with storage means for storing the lock when not in use.

Another problem with prior art hasps, shackles, and locks is that they are difficult to align for locking.

It would also be desirable to provide a hasp, shackle, and lock that are easy to align for locking.

Another problem with prior art hasps is that they require shackles and locks, both of which are difficult to apply and can be easily mislaid.

It would therefore also be desirable to provide a hasp that also functions as a lock, thereby removing the need for a separate lock and separate shackle.

Other objects and advantages of the present invention will become apparent after reading the present specification and reviewing the accompanying drawings.

### BRIEF DESCRIPTION OF THE INVENTION

There is thus provided, in accordance with some preferred embodiments of the present invention, a locking device for cooperation with a separate shackle-less padlock for locking two separate adjacent objects or immobilizing relative movement between the objects, the device comprising a hasp assembly comprising at least one hasp element for securing to at least one of the objects, provided with at least one integral shackle pin designed to be engaged in a locked position with the padlock, so that the padlock serves to prevent disengagement of the objects or to immobilize relative motion between the objects.

Furthermore, in accordance with some preferred embodiments of the present invention, two shackle pins are provided on one hasp element.

Furthermore, in accordance with some preferred embodiments of the present invention, the device is further provided with the padlock, the padlock provided with engagement means for engaging with the hasp assembly or for engaging with either of the objects or all of them.

Furthermore, in accordance with some preferred embodiments of the present invention, the engagement means comprises detachable engagement means.

Furthermore, in accordance with some preferred embodiments of the present invention, the engagement means comprises at least one protruding pin.

Furthermore, in accordance with some preferred embodiments of the present invention, said at least one hasp element includes at least one bore through which the protruding pin may be passed and further protrude.

Furthermore, in accordance with some preferred embodiments of the present invention, the hasp element is provided with protection walls for protecting the padlock when the padlock is locked.

Furthermore, in accordance with some preferred embodiments of the present invention, the device is further provided with at least one additional shackle pin protruding from an external surface of the hasp assembly for engaging the padlock when not in use.

Furthermore, in accordance with some preferred embodiments of the present invention, the hasp assembly comprises two hasp elements, each hasp element for securing to an object, and wherein at least one of the hasp elements is provided with an integral shackle pin for locking to the pad lock.

Furthermore, in accordance with some preferred embodiments of the present invention, the hasp assembly comprises two hasp elements, each hasp element for securing to an object, and wherein each of the hasp elements is provided with an integral shackle pin for locking to the pad lock.

Furthermore, in accordance with some preferred embodiments of the present invention, at least one space is defined within the hasp assembly into which said at least one integral shackle pin protrudes, the space designed to accept at least partially the shackle-less padlock.

Furthermore, in accordance with some preferred embodiments of the present invention, two spaces are defined within the hasp assembly, wherein into each of the spaces at least one shackle pin protrudes, each of the spaces designed to accept at least partially a shackle-less padlock.

Furthermore, in accordance with some preferred embodiments of the present invention, the space is shaped to match the shape of the padlock, for enhancing gripping between the hasp elements.

Furthermore, in accordance with some preferred embodiments of the present invention, said at least one shackle pin is coupled to said hasp assembly in a manner that allows relative freedom of motion between the hasp assembly and the shackle pin.

Furthermore, in accordance with some preferred embodiments of the present invention, the two hasp elements are designed to be intertwined.

Furthermore, in accordance with some preferred embodiments of the present invention, the two hasp elements are designed to grip each other, when intertwined.

Furthermore, in accordance with some preferred embodiments of the present invention, the hasp assembly is provided with a cavity into which a pin of the shackle-less padlock may be inserted.

Furthermore, in accordance with some preferred embodiments of the present invention, said at least one integral shackle pin is detachable from the hasp assembly.

Furthermore, in accordance with some preferred embodiments of the present invention, there is provided a locking device for locking two separate adjacent objects or immobilizing relative movement between the objects, the device comprising a hasp assembly comprising two hasp elements to be secured, to either of the objects, the hasp assembly provided with at least one protruding element on one hasp element and a matching cavity on the other hasp element, and an integral locking mechanism, whereby when the hasp elements are brought together they intertwine and grip each other in a locked position, preventing disengagement of the two hasp elements along at least two substantially perpendicular axes, and the locking mechanism is used to lock the hasp elements and prevent disengagement.

Furthermore, in accordance with some preferred embodiments of the present invention, the hasp assembly is provided with a plurality of protruding elements on one hasp element and a plurality of matching cavities on the other hasp element.

Furthermore, in accordance with some preferred embodiments of the present invention, said at least one protruding element has a shape that is wider on a distal end and narrower on a proximal end, and wherein the matching cavity has a complementary opposite shape.

Furthermore, in accordance with some preferred embodiments of the present invention, said at least one protruding element is in the shape of a wedge.

Furthermore, in accordance with some preferred embodiments of the present invention, the locking mechanism is located in one of the hasp elements and comprising a protrusion, while the other hasp element comprises a cavity for receiving the protrusion of the locking mechanism in a locked position.

### BRIEF DESCRIPTION OF THE FIGURES

The invention is described herein, by way of example only, with reference to the accompanying Figures, in which like components are designated by like reference numerals.

FIG. 1 is a section view of a prior art hasp and padlock.

FIG. 2A is an exploded view of a prior art protective hasp and padlock.

FIG. 2B is the view of FIG. 2 showing the recesses for the hasp and padlock in dashed lines.

FIG. 2C is a view of a locked prior art protective hasp and padlock showing the recessed hasp and padlock in dashed lines.

FIG. 3 is a section view of a protective hasp with integrated shackle pins in accordance with a preferred embodiment of the present invention.

FIG. 4 is a section view of a protective hasp with integrated flexible-mounted shackle pins in accordance with an alternative embodiment of the present invention.

FIG. 5 is a section view of a protective hasp with integrated flexible-mounted shackle pins in accordance with an alternative embodiment of the present invention.

FIG. 6A is a section view of a protective hasp with integrated shackle pin and lock with integrated lock-shackle pin in accordance with an alternative embodiment of the present invention.

FIG. 6B is a section view of the protective hasp and lock of FIG. 5A in a locked state.

FIG. 7 is a section view of a protective hasp with integrated flexible-mounted shackle pin and lock with integrated lock-shackle pin in accordance with an alternative embodiment of the present invention.

FIG. 8 is a section view of a protective hasp with an integrated alternative flexible-mounted shackle pin and an integrated fixed shackle pin in accordance with an alternative embodiment of the present invention.

FIG. 9 is a section view of a protective hasp retrofitted with integrated shackle pins in accordance with an alternative embodiment of the present invention.

FIG. 10 is a section view of a protective hasp fitted with removable shackle pins in accordance with an alternative embodiment of the present invention.

FIG. 11 is a section view of a protective hasp fitted with an integrated shackle pin and a removable shackle pin in accordance with an alternative embodiment of the present invention.

FIG. 12 is a section view of a protective hasp with integrated shackle pins in accordance with an alternative embodiment of the present invention.

FIG. 13 is an elevation view of a protective hasp with lock storage means in accordance with an alternative embodiment of the present invention.

FIG. 14 is an elevation view of a protective hasp with means for using multiple locks in accordance with an alternative embodiment of the present invention.

FIG. 15A is a section view of a protective hasp and lock with integrated wide-head lock-shackle pins in accordance with an alternative embodiment of the present invention.

FIG. 15B is a section view of the protective hasp and lock of with the lock inserted into the hasp.

FIG. 15C is a section view of the protective hasp and lock of with the lock locked into the hasp.

FIG. 16A is a front elevation view of a protective hasp with alternative shackle means in accordance with an alternative embodiment of the present invention.

FIG. 16B is a top section view of the protective hasp of FIG. 16A.

FIG. 16C is an elevation view of a lock for the protective hasp of FIG. 16A and FIG. 16B.

FIG. 16D is a top view of the lock from FIG. 16C in a locked state.

FIG. 16E is a top view of the lock from FIG. 16C in an unlocked state.

FIG. 17 is a top section view of a protective hasp and lock with alternative shackle means in accordance with an alternative embodiment of the present invention.

FIG. 18A is a section view of a protective hasp with a hinged shackle pin and a fixed shackle in accordance with an alternative embodiment of the present invention.

FIG. 18B is a side view of the embodiment shown in FIG. 18A.

FIG. 19 is a section view of a protective hasp with an extended shackle pin in accordance with an alternative embodiment of the present invention.

FIG. 20A is a front elevation view of a protective hasp with shackle means for front locking in accordance with an alternative embodiment of the present invention.

FIG. 20B is a side view of the embodiment shown in FIG. 20A.

FIG. 21A is a top view of a hasp with integrated perpendicular shackle pin and lock for locking a sliding object in accordance with an alternative embodiment of the present invention.

FIG. 21B is a top view of a hasp with integrated perpendicular shackle pins and lock for locking a sliding object in accordance with an alternative embodiment of the present invention.

FIG. 22A is a top view of a hasp with integrated parallel shackle pin and lock for locking a sliding object in accordance with an alternative embodiment of the present invention.

FIG. 22B is a top view of a hasp with integrated parallel shackle pins and lock for locking a sliding object in accordance with an alternative embodiment of the present invention.

FIG. 23A is a top view of a hasp with integrated perpendicular shackle pin and lock with integrated lock-shackle pin for locking sliding objects in accordance with an alternative embodiment of the present invention.

FIG. 23B is a top view of a hasp with integrated parallel shackle pin and lock with integrated lock-shackle pin for locking sliding objects in accordance with an alternative embodiment of the present invention.

FIG. 23C is a top view of a hasp with integrated perpendicular shackle pins and lock with integrated lock-shackle pin for locking sliding objects in accordance with an alternative embodiment of the present invention.

FIG. 23D is a top view of a hasp with integrated parallel shackle pins and lock with integrated lock-shackle pin for locking sliding objects in accordance with an alternative embodiment of the present invention.

FIG. 24A is a top view of a hasp with integrated perpendicular shackle pins and lock with integrated lock-shackle pin for locking a swinging object in accordance with an alternative embodiment of the present invention.

FIG. 24B is a top view of a lock with integrated lock-shackle pins for locking swinging objects in accordance with an alternative embodiment of the present invention.

FIG. 24C is a top view of a lock with integrated shaped lock-shackle pins for locking swinging objects in accordance with an alternative embodiment of the present invention.

FIG. 24D is a bottom view of a lock with integrated shaped lock-shackle pins for locking swinging objects in accordance with an alternative embodiment of the present invention.

FIG. 25A is a side section view of a protective hasp with integrated shackle pins in accordance with an alternative embodiment of the present invention.

FIG. 25B is a front section view of the embodiment illustrated in FIG. 25A. FIG. 26 is an elevation view of a protective hasp in accordance with an alternative embodiment of the present invention.

FIG. 27 is a section view of a protective hasp with wedge-toothed abutting walls in accordance with an alternative embodiment of the present invention.

FIG. 28 is a section view of a protective hasp with wedge-toothed abutting walls in accordance with an alternative embodiment of the present invention.

FIG. 29A is an elevation view of a protective hasp with integrated lock in accordance with an alternative embodiment of the present invention.

FIG. 29B is an elevation view of the embodiment of FIG. 29A protective hasp, illustrating the two hasp sections locked together.

FIG. 30A is an elevation view of a protective hasp with parallelograms interlocking abutting walls of hasp sections in accordance with an alternative embodiment of the present invention.

FIG. 30B is an elevation view of a protective hasp with alternatingly-oriented parallelograms interlocking abutting walls of hasp sections in accordance with an alternative embodiment of the present invention.

FIG. 31A is an elevation view of a protective hasp with interlocking abutting walls of circular projections in accordance with an alternative embodiment of the present invention.

FIG. 31B is an elevation view of a protective hasp with interlocking abutting walls of elliptical projections in accordance with an alternative embodiment of the present invention.

FIG. 32 is an elevation view of a protective hasp with interlocking abutting walls with jointed projections in accordance with an alternative embodiment of the present invention.

FIG. 33A is an elevation view of a protective hasp with interlocking abutting walls with unequal jointed projections in accordance with an alternative embodiment of the present invention.

FIG. 33B is a cross-section view of the hasp of FIG. 33A along the line delineated (A-A) in FIG. 33A of a protective hasp with interlocking abutting walls with unequal jointed projections in accordance with an alternative embodiment of the present invention.

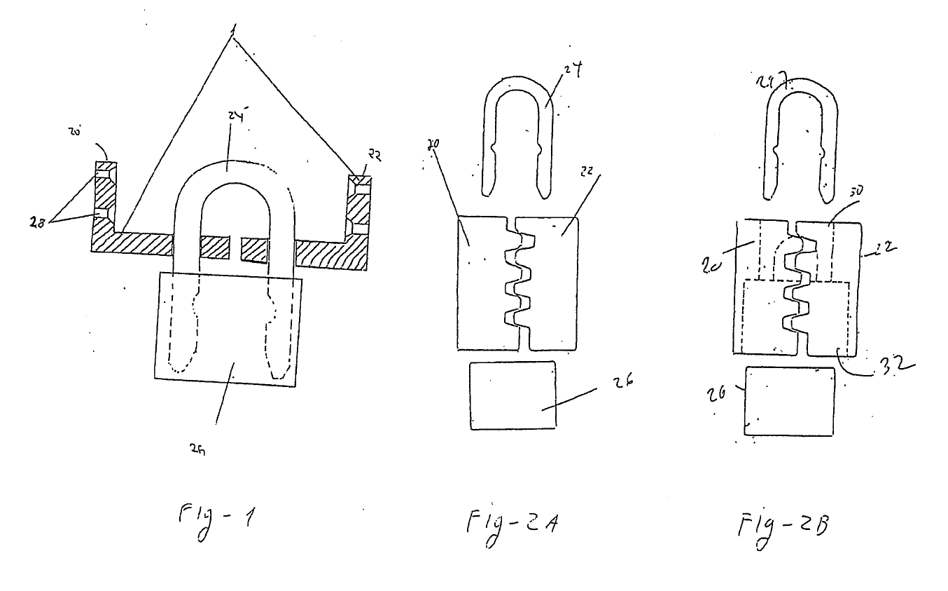

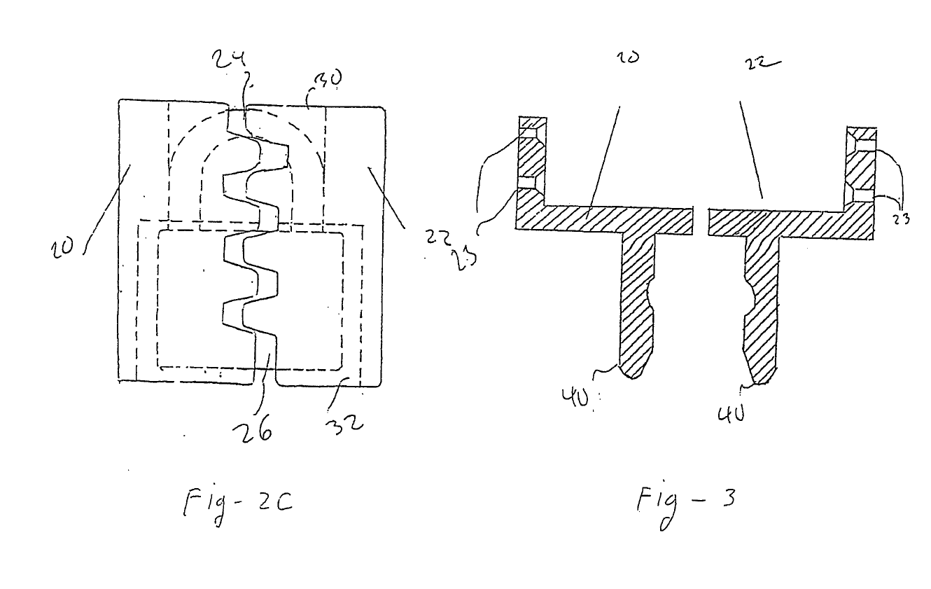

### DETAILED DESCRIPTION OF THE INVENTION

The present invention provides an improved hasp, shackle, and lock. In the invention the shackle is integrated into the hasp sections, lock, or both. This eliminates problems related to inserting and removing the shackle and related to keeping track of the shackle when not in use. The shackle legs are implemented in the present inventions as projections of the hasp section, lock, or both and are referred to herein as shackle pins.

The invention also provides means for increasing lateral locking strength, means for installing the lock from the side, means for installing more than one lock, means for storing a lock when not in use, means for using a single hasp section to lock a swinging or sliding object, means for facilitating alignment of hasp sections, and means for integrated locking functions into hasp sections whereby neither a separate lock nor a separate shackle is required.

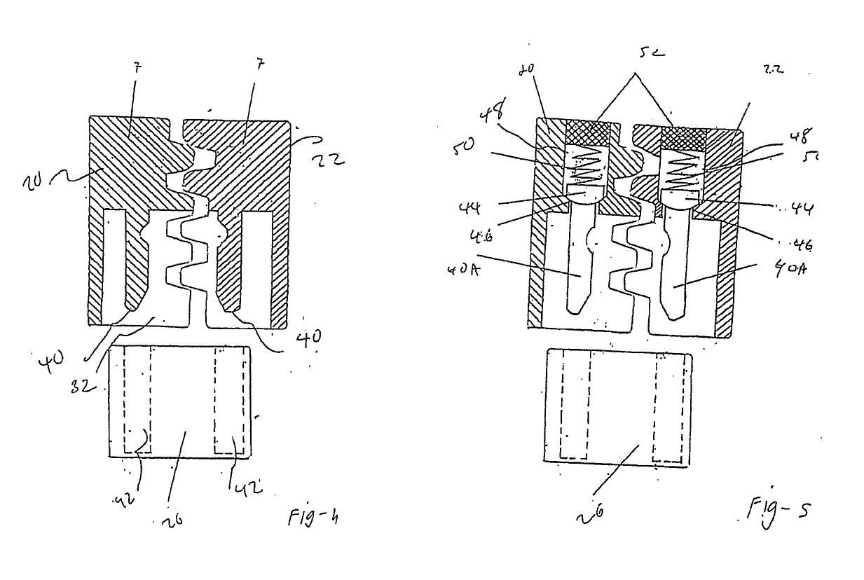

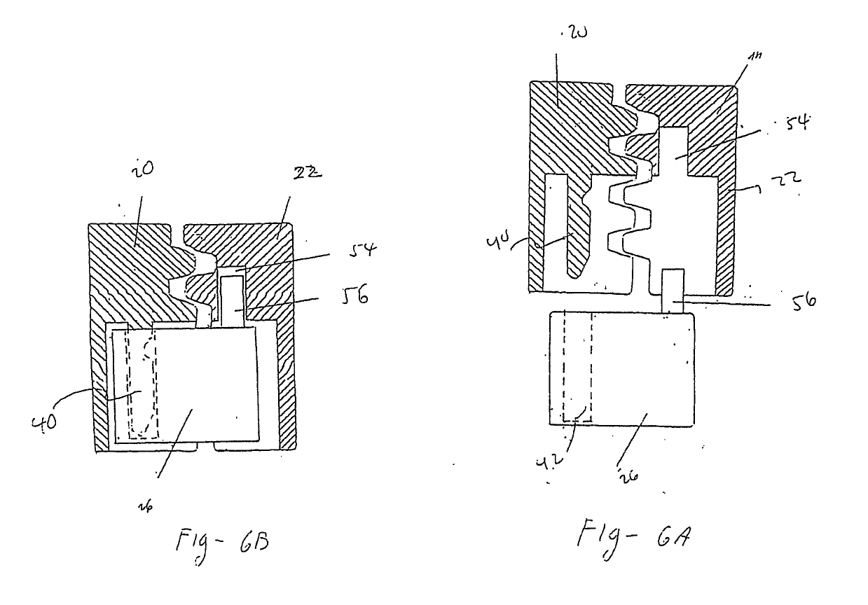

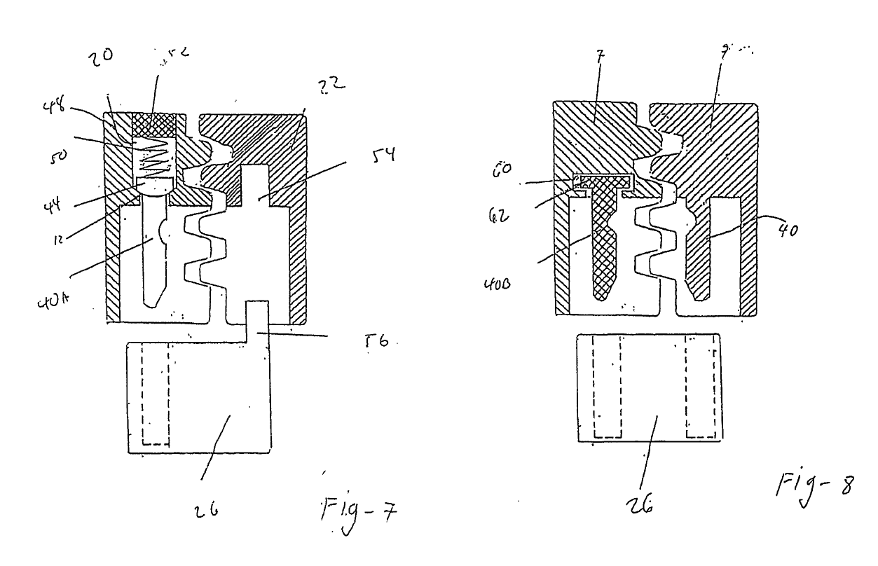

FIG. 3 is a section view of a hasp with integrated shackle pins in accordance with a preferred embodiment of the present invention. Each hasp section 20 and 22 comprises a projecting shackle pin 40, which acts as a shackle leg. Also shown are hasp mounting bores 23 through which fastening means, such as screws, rivets, or welds can mount each hasp section to an element to be locked, such as a door and a door frame. It will be noted that mounting bores 23 are a common means in the art for mounting hasps and are therefore used in this specification—however there are many other means for mounting hasps that are known to one skilled in the art, for example welding, and these could equally be used.

FIG. 4 is a section view of a protective hasp with integrated shackle pins in accordance with a preferred embodiment of the present invention. Each hasp section 20 and 22 comprises a shackle pin 40 projecting into lock recess 32. The embodiment can be used with a shackle-less padlock 26, which accepts shackle pins 40 into its receptacles 42 intended for prior art shackle 24 legs.

FIG. 5 is a section view of a protective hasp with flexible integrated shackle pins in accordance with an alternative embodiment of the present invention. Flexible-mounted shackle pins 40A provide play when they are inserted into lock 26, thereby making insertion easier. The flexible mounting can be accomplished in many ways known to those skilled in the art. In the Figure, flexible-mounted shackle pins 40 comprise a widened head 44 that is retained in channel 48 by narrowing 46. Shackle pin 40 is subjected to force of backing spring 50 and both are retained by channel plug 52.

FIG. 6A is a section view of a protective hasp and lock with integrated shackle and lock-shackle pins in accordance with an alternative embodiment of the present invention. In this embodiment, one shackle pin 40 is integrated into hasp section 20 while another shackle pin is integrated into lock 26 (referred to herein as lock-shackle pin 56 to differentiate it from shackle pin 40). Lock-shackle pin 56 is a projection of lock 26 that mates into a pin recess 54 in hasp section 22.

FIG. 6B illustrates the embodiment of FIG. 6A in a locked state with lock shackle pin 56 retained in pin recess 54 and shackle pin 40 held by lock 26.

FIG. 7 is a section view of a protective hasp and lock with integrated flexible-mounted shackle pin and lock-shackle pin in accordance with an alternative embodiment of the present invention. Thus this embodiment functions like the embodiment illustrated in FIG. 6A and FIG. 6B with the added advantage that flexible-mounted shackle pin 40A provides play during insertion into lock 26.

FIG. 8 is a section view of a protective hasp with an integrated alternative flexible-mounted shackle pin and an integrated fixed shackle pin in accordance with an alternative embodiment of the present invention. Alternative flexible-mounted shackle pin 40B comprises a widened head 62 that is retained in channel 60.

FIG. 9 is a section view of a protective hasp retrofitted with integrated shackle pins in accordance with an alternative embodiment of the present invention. Retro-fit shackle pin 40C enables conversion of a prior art shackle section to operate in accordance with the principles of the present invention. Retro-fit shackle pin 40C comprises a pin 66 that fits into the existing shackle channel and extends down to provide a shackle pin as has been described in accordance with the present invention. Retro-fit shackle pin 40C is retained in place with a fastening means, such as retaining screw 64 which passes through retaining-screw bore 70, which can be a dedicated bore or can be a mounting bore of shackle section 20 or 22.

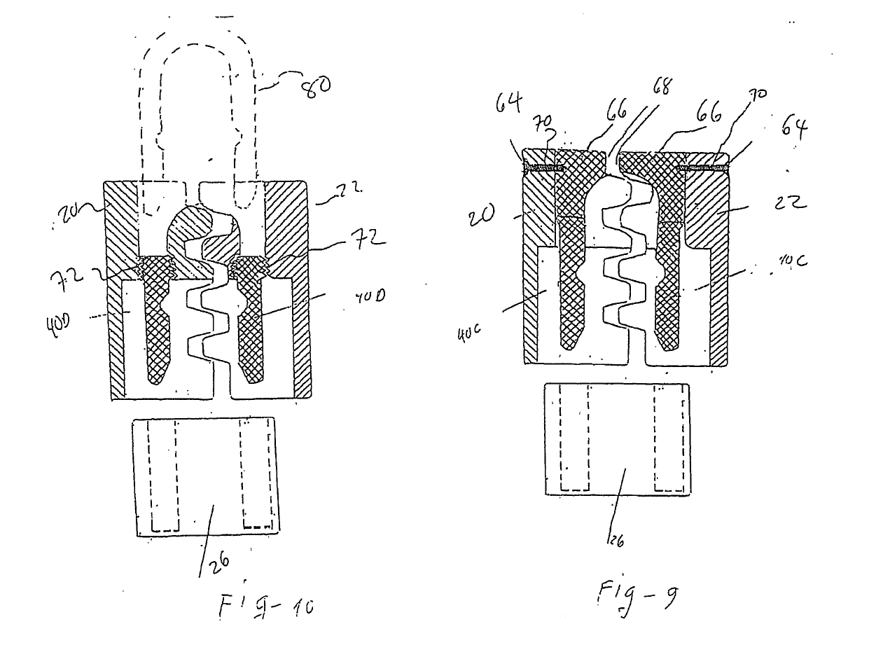

FIG. 10 is a section view of a protective hasp fitted with removable shackle pins in accordance with an alternative embodiment of the present invention. Removable shackle pins 40D is installed fastening means, such as by threading into threaded bore 72 in shackle channel of hasp sections 20 and 22. When removable shackle pin 40D is installed, hasps sections 20 and 22 function according to the principles of the present invention. When removable shackle pin 40D is removed, hasps sections 20 and 22 function according to the principles of prior art, receiving prior art shackle 80.

FIG. 11 is a section view of a protective hasp fitted with an integrated shackle pin and a removable shackle pin in accordance with an alternative embodiment of the present invention. This embodiment provides a hasp section 20 with removable shackle pin 40D installed and a hasp section 22 with an integrated shackle pin 40.

FIG. 12 is a section view of a protective hasp with integrated shackle pins in accordance with an alternative embodiment of the present invention. In this embodiment both shackle pins 40 are on hasp section 22 and lock recess 32 is built across hasp sections 20 and 22, whereby lock 26 can be installed from the side, rather than from the bottom as in the embodiments described earlier.

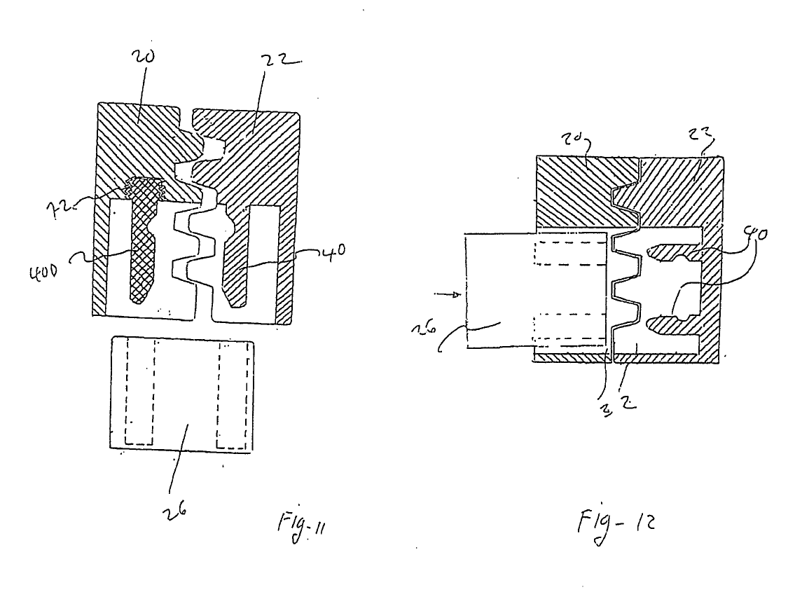

FIG. 13 is an elevation view of a protective hasp with lock storage means in accordance with an alternative embodiment of the present invention. The lock storage means comprises removable lock pegs 86 installed in lock peg holes 88. When lock 26 is not in use, it can be locked onto pegs 86 and thereby stored. During storage the lock does not hold the hasp sections 20 and 22 together, it simply hangs to the side. Lock peg holes 88 can be arranged on various sides of hasp sections 20 and 22, such that lock pegs 86 can be installed on whichever side is most convenient.

FIG. 14 is an elevation view of a protective hasp with means for using multiple locks in accordance with an alternative embodiment of the present invention. Hasp sections 20 and 22 are elongated so accept locks 26 at both the top and bottom.

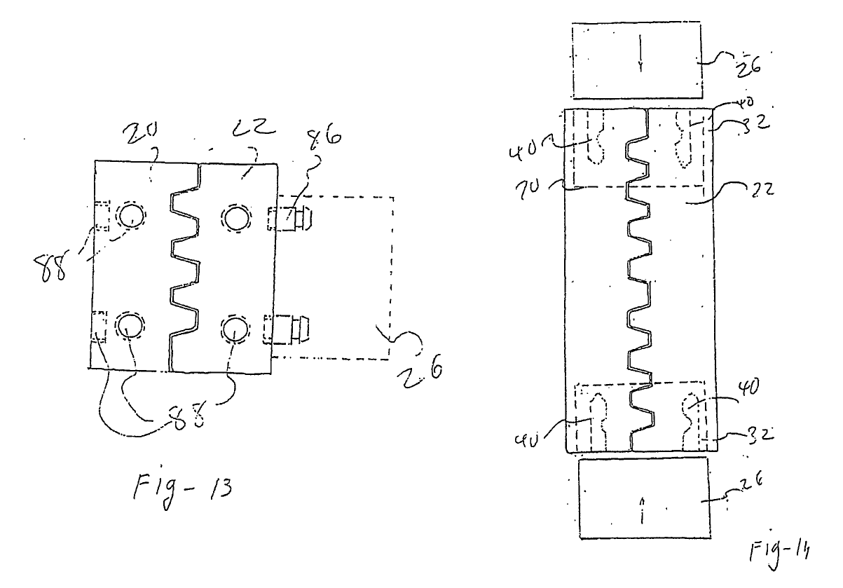

FIG. 15A is a section view of a protective hasp and lock with integrated wide-head lock-shackle pins in accordance with an alternative embodiment of the present invention. In this embodiment, pin recess 54 has a widened distal end 92 and wide-head lock-shackle pin 56 has a widened head 90.

FIG. 15B shows lock 26 in an unlocked state inserted into hasp sections 20 and 22 per this embodiment.

FIG. 15C shows lock 26 in a locked state. Wide-head lock-shackle pin 56 is connected to lock 26's bore, such that when the bore is turned (locking action), wide-head lock-shackle pin 56 is turned a half revolution, whereby widened head 90 is oriented such that it fills widened recess end 92, thereby locking wide-head lock-shackle pin 56 into recess end 92.

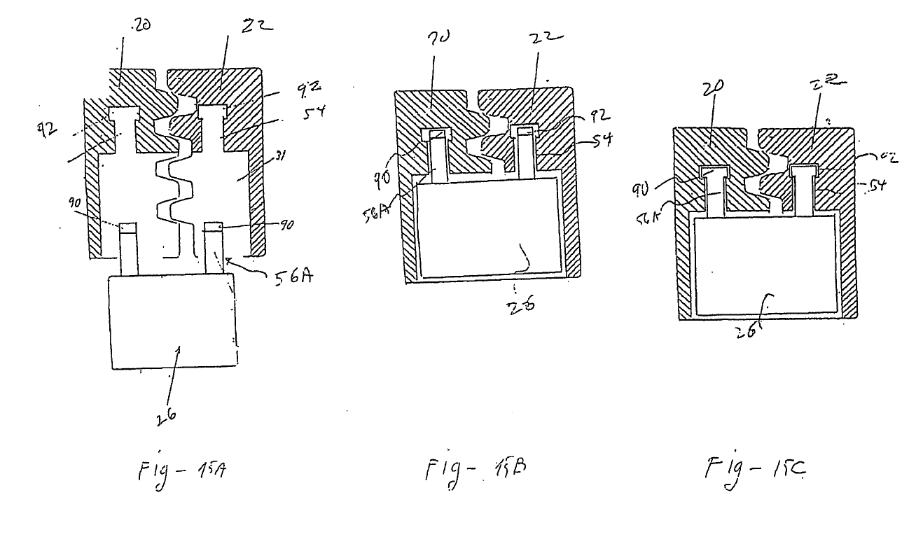

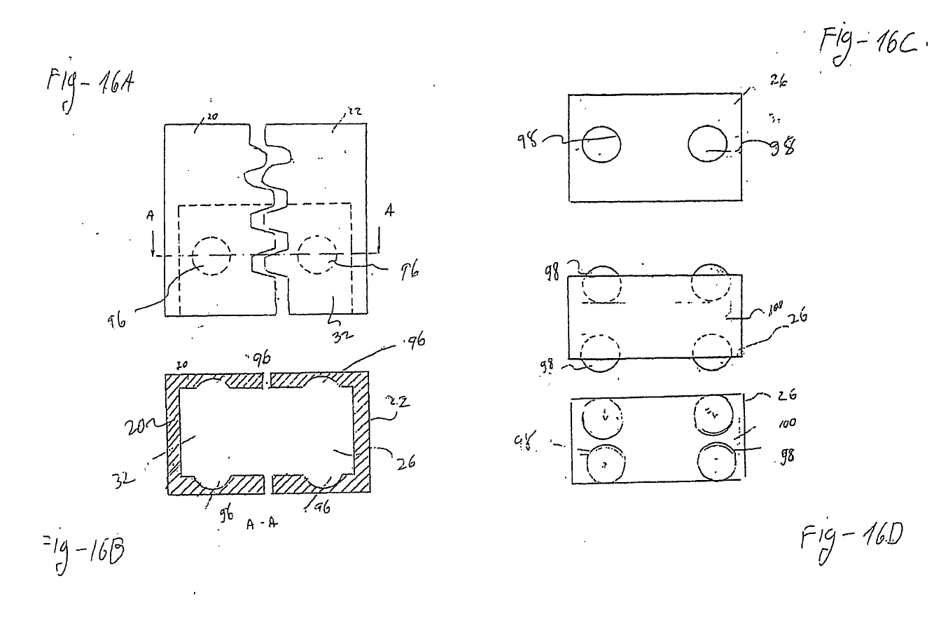

FIG. 16A is a front elevation view of a protective hasp with alternative shackle means in accordance with an alternative embodiment of the present invention. Sides of lock recess 32 (shown in dashed line) comprise alternative shackle recesses 96. The principle of this embodiment is that a retractable protrusion mates with complementary recess to perform the locking of hasp sections 20 and 22. In the Figure, this locking mechanism is illustrated as concave shackle recesses 96 in hasp sections 20 and 22 receiving convex shackle protuberances 98 from lock 26. Optionally other concave-convex shape pairs can used. For example, cone recesses and protuberances.

FIG. 16B is a top section view of the protective hasp of FIG. 16A.

FIG. 16C is a front elevation view of a lock for the protective hasp of FIG. 16A and FIG. 16B. Lock 26 comprises convex lock protuberances 98 that are shaped to complement concave hasp recesses 96.

FIG. 16D is a top view of lock 26 from FIG. 16C. Protuberance extender 100 is an elongated element mechanically connected to the plug of lock 26 and comprising cams adjacent to each concave lock protuberance 98. When the plug is turned to lock, it turns protuberance extender 100, whose cams push the adjacent lock protuberance 98 into the corresponding concave hasp recess 96, thereby locking hasp sections 20 and 22 together.

When the plug is turned to unlock, it turns protuberance extender 100 in the opposite direction, removing the cams from lock protuberances 98, thereby allowing the lock protuberances to come back into the body of lock 26 when it is removed from hasp sections 20 and 22 (FIG. 16E).

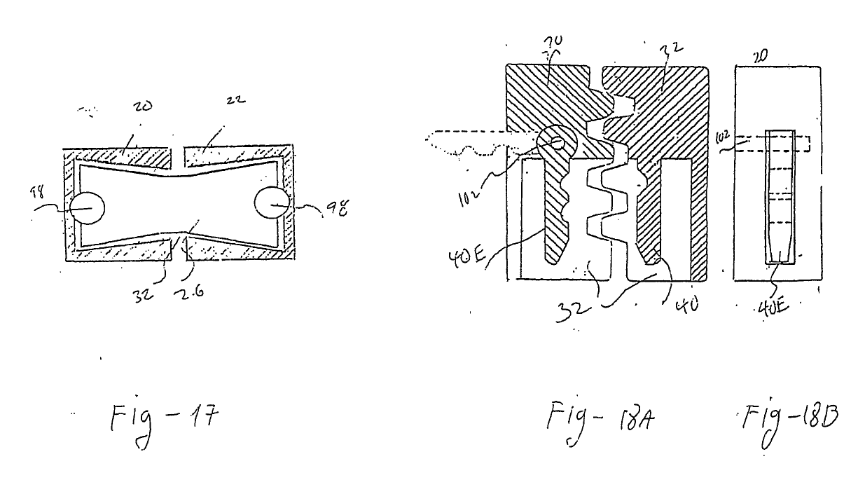

FIG. 17 is a top section view of a protective hasp and lock with alternative shackle means in accordance with an alternative embodiment of the present invention. Here lock recess is wedge shaped in each hasp section 20 and 22 and lock 26 is also wedge shaped such that the wedge shape of lock 26 contributes to the strength of the locking of the hasp sections.

FIG. 18A is a section view of a protective hasp with a hinged shackle pin and a fixed shackle in accordance with an alternative embodiment of the present invention. Hinged shackle pin 40E is pivotally connected via hinge 102 to hasp section 20. When pivoted down, hinged shackle pin 40E functions as a shackle pin. When pivoted up (shown in the drawing with a dashed line), hinged shackle pin 40E provides a surface on which lock 26 can be locked for storage.

FIG. 18B is a side view of the embodiment shown in FIG. 18A.

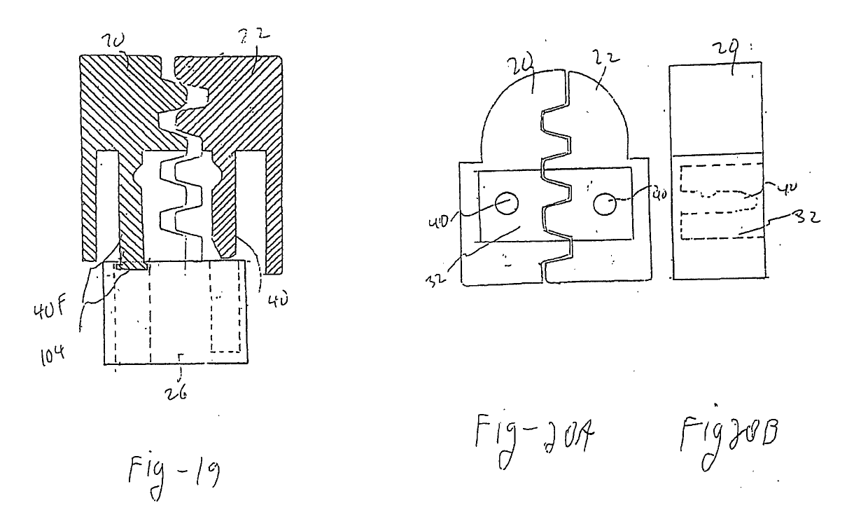

FIG. 19 is a section view of a protective hasp with an extended shackle pin in accordance with an alternative embodiment of the present invention. Extended shackle pin 40F features a widening 104 at its distal end. Lock 26 can be locked to widening 104 for storage when not in use.

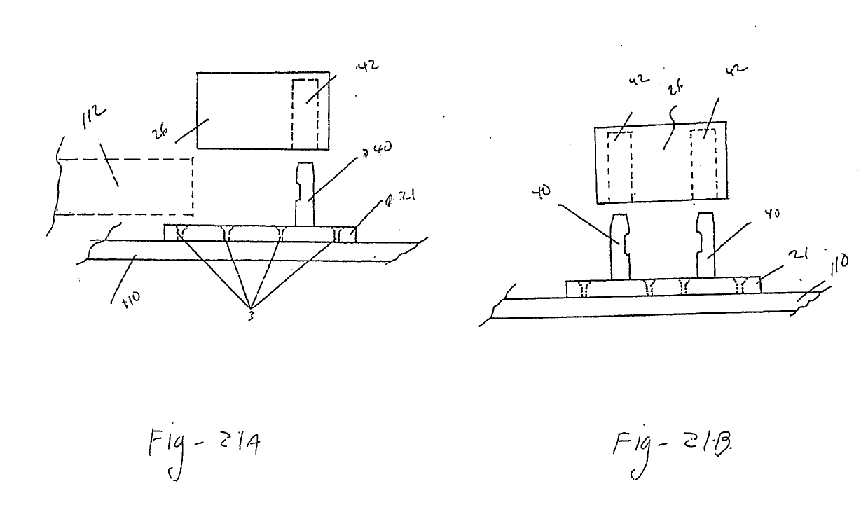

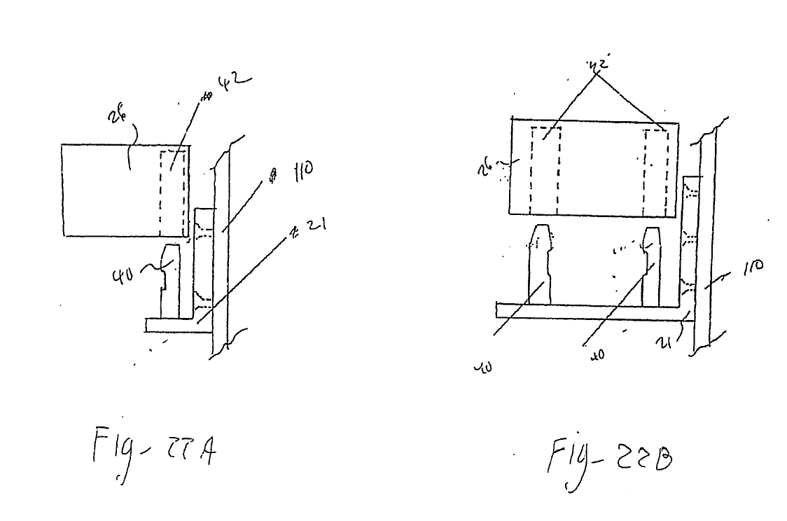

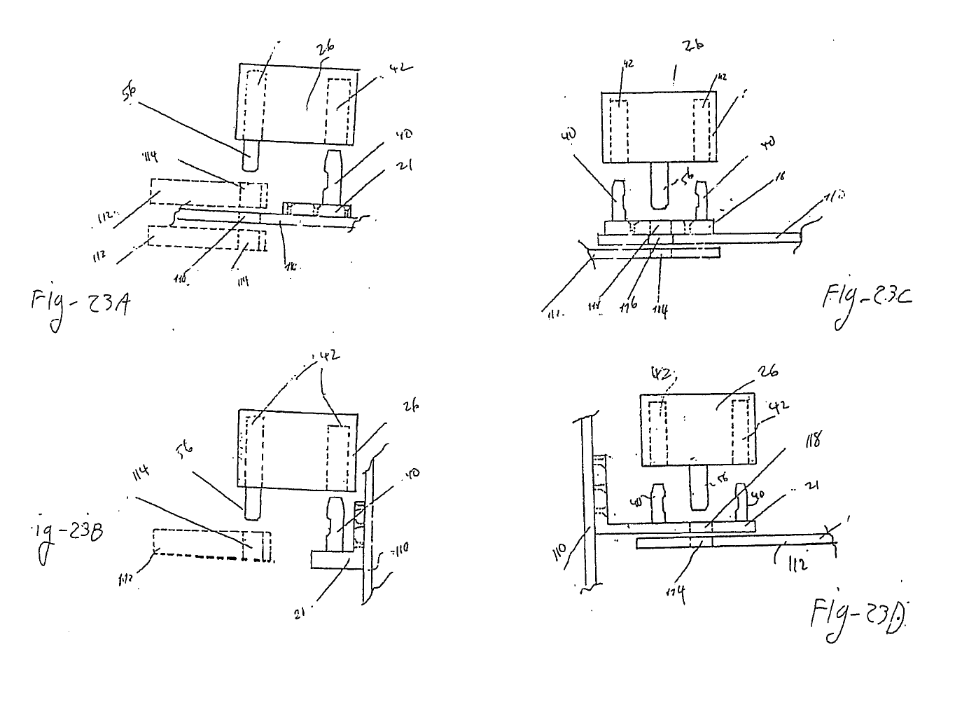

FIG. 20A is a front elevation view of a protective hasp with shackle means for front locking in accordance with an alternative embodiment of the present invention. Lock recess 32 and shackle pins 40 are located on the front of hasp sections 20 and 22 such that lock 26 can be inserted into the front of the hasp sections. FIG. 20B is a top view of the embodiment shown in FIG. 20A with lock recess 32 and shackle pin 40 indicated with a dashed line.

FIG. 21A is a top view of a hasp with integrated perpendicular shackle pin and lock for locking a sliding object in accordance with an alternative embodiment of the present invention. Hasp 21 is mounted through mounting bores 23 to a first object 110, such that shackle pin 40 extends perpendicular to the mounting base of hasp 21 and is received by lock into shackle leg receptacle 42 (indicated with a dashed line), which can be a dedicated receptacle or that used for a prior art shackle leg. Lock 26 is locked in place using a locking means such as a key and thereby blocks lateral movement of second object 112 in the direction of shackle pin 40.

FIG. 21B is a top view of a hasp with integrated perpendicular shackle pins and lock for locking a sliding object in accordance with an alternative embodiment of the present invention. It illustrates that more than one perpendicular shackle pin 40 and mating receptacle 42 combination can be used.

FIG. 22A is a top view of a hasp with integrated parallel shackle pin and lock for locking a sliding object in accordance with an alternative embodiment of the present invention. Hasp 21 is mounted to a first object 110, such that shackle pin 40 extends parallel to the mounting plane of hasp 21 and is received into lock 26 shackle leg receptacle 42. Lock 26 is locked in place using a locking means such as a key and thereby blocks movement of a second object perpendicular to shackle pin 40.

FIG. 22B is a top view of a hasp with integrated parallel shackle pins and lock for locking a sliding object in accordance with an alternative embodiment of the present invention. It illustrates that more than one perpendicular shackle pin 40 and mating receptacle 42 combination can be used.

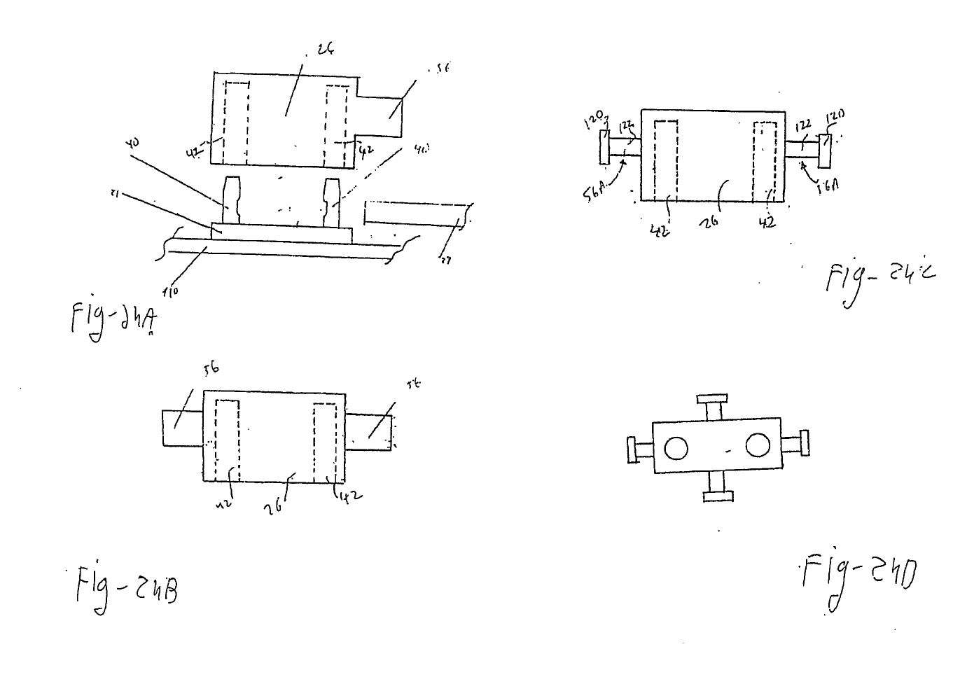

FIG. 23A is a top view of a hasp with integrated perpendicular shackle pin and lock with integrated lock-shackle pin for locking sliding objects in accordance with an alternative embodiment of the present invention. Hasp 21 is mounted to a first object 110, such that shackle pin 40 extends perpendicular to the mounting base of hasp 21 and is received by lock into shackle leg receptacle 42. Lock 26 further comprises lock-shackle pin 56, which extends through second object bore 114 and first object bore 116, thereby locking second object 112 to first object 110. It will be noted that second object 112 can be above or below first object 110—both possibilities are illustrated in the Figure.

FIG. 23B is a top view of a hasp with integrated parallel shackle pin and lock with integrated lock-shackle pin for locking sliding objects in accordance with an alternative embodiment of the present invention. Hasp 21 is mounted to a first object 110, such that shackle pin 40 extends parallel to the mounting plane of hasp 21 and is received into lock 26 shackle leg receptacle 42. Lock 26 further comprises lock-shackle pin 56, which extends through second object bore 114, thereby preventing lateral movement of second object 112.

FIG. 23C is a top view of a hasp with integrated perpendicular shackle pins and lock with integrated lock-shackle pin for locking sliding objects in accordance with an alternative embodiment of the present invention. Hasp 21 is mounted to a first object 110, such that shackle pins 40 extend perpendicular to the mounting base of hasp 21 and are received by lock into shackle leg receptacles 42. Lock 26 further comprises lock-shackle pin 56, which extends through hasp bore 118, second object bore 114, and first object bore 116, thereby locking second object 112 to first object 110.

FIG. 23D is a top view of a hasp with integrated parallel shackle pins and lock with integrated lock-shackle pin for locking sliding objects in accordance with an alternative embodiment of the present invention. Hasp 21 is mounted to a first object 110, such that shackle pins 40 extend parallel to the mounting plane of hasp 21 and are received into lock 26 shackle leg receptacle 42. Lock 26 further comprises lock-shackle pin 56, which extends through hasp bore 118 and second object bore 114, thereby preventing lateral movement of second object 112.

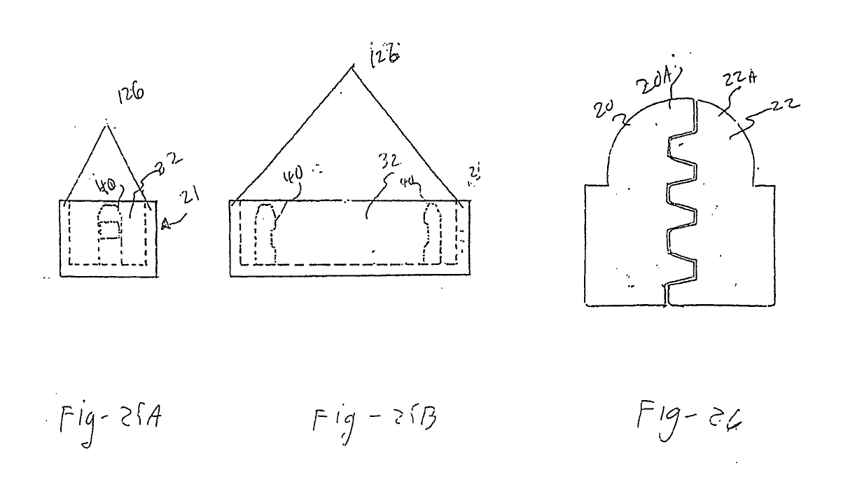

FIG. 24A is a top view of a hasp with integrated perpendicular shackle pins and lock with integrated lock-shackle pin for locking a swinging object in accordance with an alternative embodiment of the present invention. Hasp 21 and lock 26 are similar to the embodiment of FIG. 23B. Lock 26 further comprises lock engagement means 56, which projects above the top surface of second object 112, thereby preventing upward swinging motion of second object 112 relative to first object 110.

FIG. 24B is a top view of a lock with integrated lock-shackle pins for locking swinging objects in accordance with an alternative embodiment of the present invention. Hasp 21 (not shown) and lock 26 are similar to the embodiment of FIG. 26A with lock 26 further comprising an additional lock-engagement means 56, whereby the lock can prevent upward swinging motion of two second objects 112 (not shown), one by each lock-shackle pin 56.

FIG. 24C is a top view of a lock with integrated shaped lock-shackle pins for locking swinging objects in accordance with an alternative embodiment of the present invention. Hasp 21 (not shown) and lock 26 are similar to the embodiment of FIG. 26B with lock-engagement means 56A having a shaped head 120, an example of the head shape being an elongation perpendicular to pin stem 122. Second objects 112 (not shown) include head sockets shaped to receive heads 120, thereby improving the fit of lock-engagement means 56A to the second object surface.

FIG. 24D is a bottom view of a lock with integrated shaped lock-shackle pins for locking swinging objects in accordance with an alternative embodiment of the present invention. Hasp 21 (not shown) and lock 26 are similar to the embodiment of FIG. 26C with lock-shackle pins 56A included on each of the four sides of lock 26, whereby the lock can prevent upward swinging motion of four second objects 112 (not shown), one by each lock-engagement means 56A.

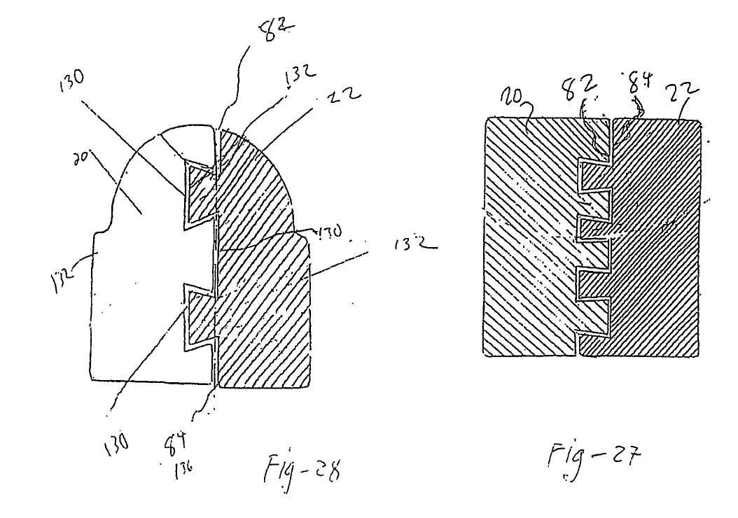

FIG. 25A is a side section view and FIG. 25B is a front section view of a protective hasp with integrated shackle pins in accordance with an alternative embodiment of the present invention. Hasp 21 comprises a protective shell 126 encasing shackle pins 40 to form a reinforced lock recess 32 that protects lock 26 when the lock is in use. Protective shell 126 can be implemented as covering one, two, three, or all four sides of lock.

FIG. 26 is an elevation view of a protective hasp in accordance with an alternative embodiment of the present invention. Hasp sections 20 and 22 are provided with rounded upper sections 20A and 22A, thereby making them easier to hold and align as well as more pleasing aesthetically.

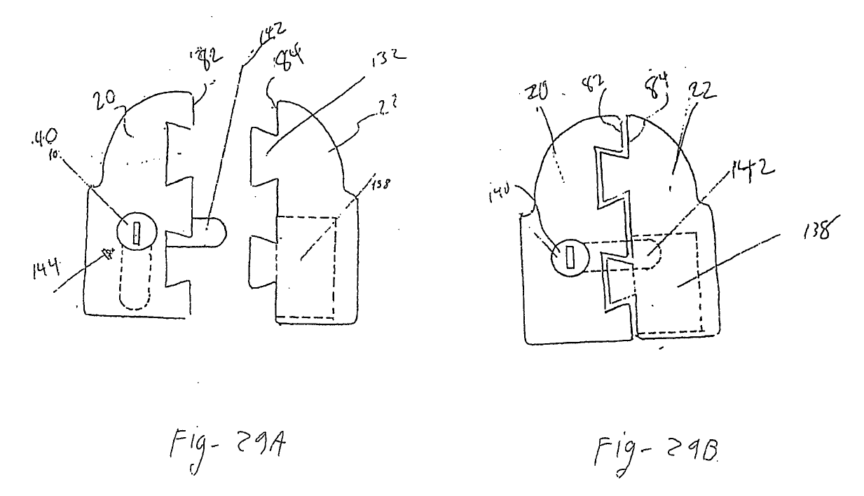

FIG. 27 is a section view of a protective hasp with interlocking abutting walls in accordance with an alternative embodiment of the present invention. The vertical abutting walls of hasp sections 20 and 22 are provided with interlocking profiles 82 and 84 respectively.

The principle of this design is presented in more simple form in FIG. 28, which is an elevation view of a protective hasp with interlocking abutting walls in accordance with an alternative embodiment of the present invention. Hasp sections 20 and 22 comprise abutment surfaces 82 and 84 respectively. Abutment surfaces 82 and 84 are characterized in that there is at least one male projection 132 in one of the abutment surfaces with a complementary female recess 130 in the other abutment surface such that the male projection 132 can be slid into the female recess 130 by aligning one hasp section behind the other such that the contour of each male projection 132 is aligned with the inner perimeter of each complementary female recess 130. At that point, the rear hasp section can be brought forward until the two hasp sections are coplanar, thereby intertwining and gripping the hasp sections along abutment surfaces 82 and 84. This creates a fixed connection (locks) the hasp sections along the two coplanar dimensions (laterally). In the embodiment shown in FIG. 28, male projection 132 is a wedge shaped extension while female recess 130 is a wedge shaped recess.

This innovative connection has at least two advantages: it makes it easier to align the two hasp sections, even allowing the use of just one hand for this purpose, and it makes it possible to integrate a simple locking element in the hasp sections, thereby eliminating the need for a shackle or for a lock.

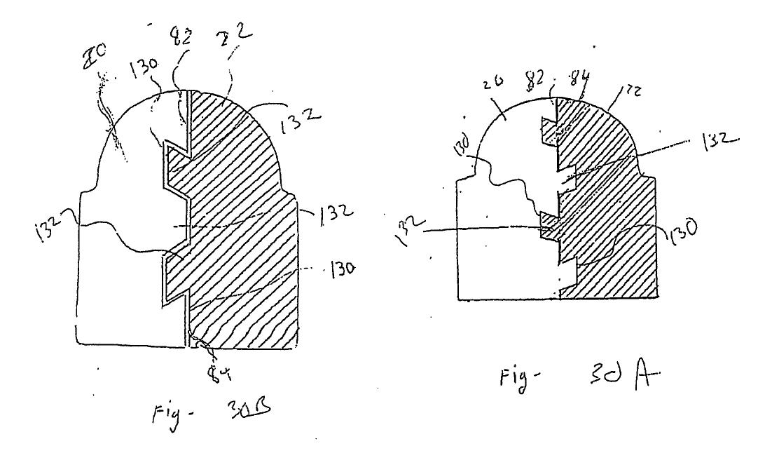

FIG. 29A is an elevation view of a protective hasp with integrated lock in accordance with an alternative embodiment of the present invention. The embodiment utilizes the wedge-toothed abutting walls described earlier, thereby achieving coplanar locking of the hasp sections. Locking in the third dimension (perpendicular to the plane of the hasp sections) is easily accomplished with many types of simple locking means. For example, in the Figure, integrated lock 144 comprises basic key-operated cylinder 140, which turns tongue 142 from a stored position (shown with dashed line) to an engaged (locking) position in which the tongue extends into tongue recess 138 or the adjacent hasp section 22. It will clear to one skilled in the art that the locking mechanism can be located in either hasp section or spread across both of the them and that many locking means can be used.

FIG. 29B is an elevation view of the embodiment of FIG. 29A protective hasp, illustrating the two hasp sections locked together.

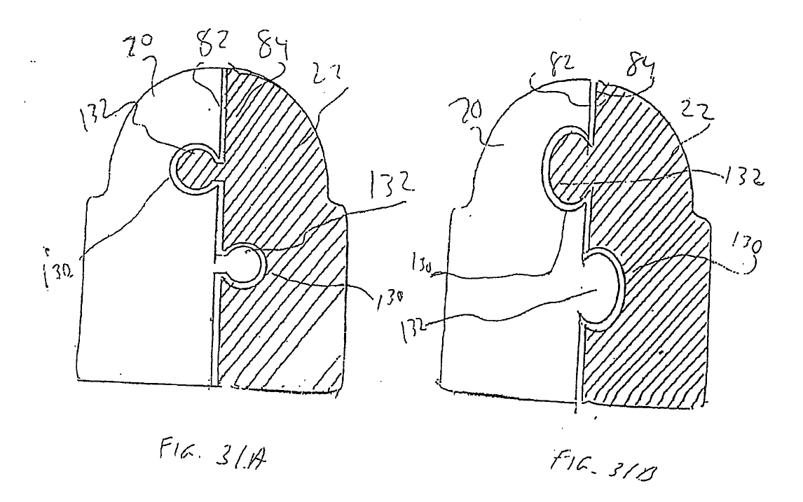

FIG. 30A is an elevation view of a protective hasp with interlocking abutting walls in accordance with an alternative embodiment of the present invention. In this embodiment the profile of along abutment surfaces 82 and 84 comprise parallelogram-shaped pairs of male projections 132 and complementary female recesses 130.

FIG. 30B is an elevation view of a protective hasp with interlocking abutting walls in accordance with an alternative embodiment of the present invention. In this embodiment the profiles of male projections 132 along abutment surface 84 comprise parallelograms that are inverted relative to one another.

FIG. 31A and FIG. 31B are elevation views of a protective hasp with interlocking abutting walls in accordance with an alternative embodiment of the present invention. In this embodiment the profiles of male projections 132 along abutment surfaces 82 and 84 comprise convex shapes, such as circles (FIG. 31A) and ellipses (FIG. 31B).

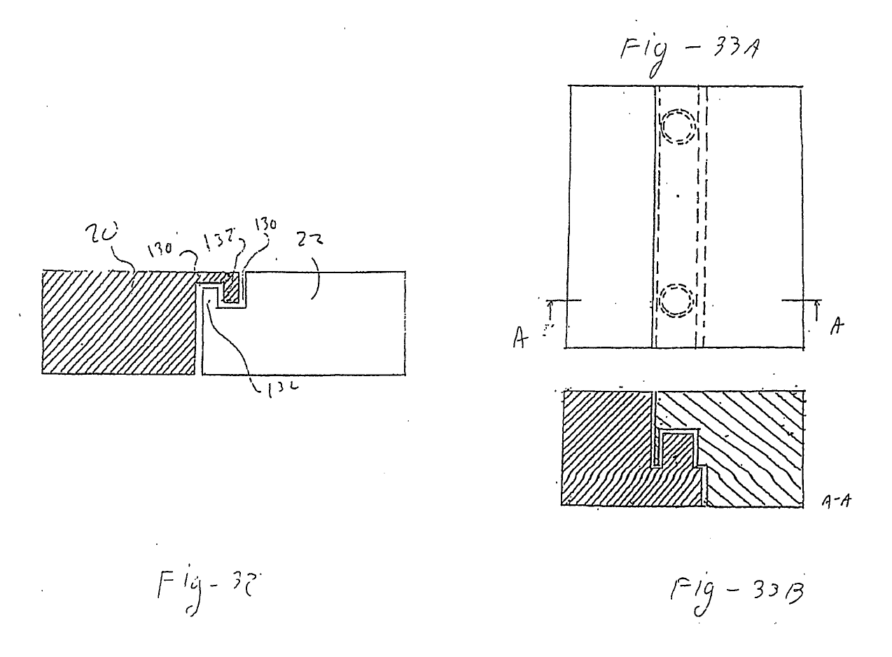

FIG. 32 is an elevation view of a protective hasp with interlocking abutting walls with projections in accordance with an alternative embodiment of the present invention. In this embodiment each hasp section has a hooked projection, here right-angled (but other configurations are also possible) that intertwines with a matching hooked projection on the other hasp section.

the profiles of male projections 132 comprise projections along one common corner of abutment surfaces 82 and 84.

FIG. 33A is an elevation view, and FIG. 33B is a cross-section view along the line delineated (A-A) in FIG. 33A of a protective hasp with interlocking abutting walls with unequal projections in the form of round pins, in accordance with an alternative embodiment of the present invention. This embodiment allows greater lateral freedom in the process of engaging both hasp sections. The profiles of the male projections 132 comprise substantially perpendicular projections along one common corner of abutment surfaces 82 and 84, with matching cavities on the other hasp section. Another advantage of this embodiment is the prevention of relative motion also in the up-down direction between the hasp sections when engaged.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A locking device for cooperation with a separate shackle-less padlock for locking two separate adjacent objects or immobilizing relative movement between the objects, the device comprising a hasp assembly comprising at least one hasp element for securing to at least one of the objects, provided with at least one integral shackle pin designed to be engaged in a locked position with the padlock, so that the padlock serves to prevent disengagement of the objects or to immobilize relative motion between the objects.

2. The device of claim 1, wherein two shackle pins are provided on one hasp element.

3. The device of claim 1, further provided with the padlock, the padlock provided with engagement means for engaging with the hasp assembly or for engaging with either of the objects or all of them.

4. The device of claim 3, wherein the engagement means comprises detachable engagement means.

5. The device of claim 3, wherein the engagement means comprises at least one protruding pin.

6. The device of claim 5, wherein said at least one hasp element includes at least one bore through which the protruding pin may be passed and further protrude.

7. The device of claim 1, wherein the hasp element is provided with protection walls for protecting the padlock when the padlock is locked.

8. The device of claim 1, further provided with at least one additional shackle pin protruding from an external surface of the hasp assembly for engaging the padlock when not in use.

9. The device of claim 1, wherein the hasp assembly comprises two hasp elements, each hasp element for securing to an object, and wherein at least one of the hasp elements is provided with an integral shackle pin for locking to the padlock.

10. The device of claim 9, wherein the hasp assembly comprises two hasp elements, each hasp element for securing to an object, and wherein each of the hasp elements is provided with an integral shackle pin for locking to the padlock.

11. The device of claim 9, wherein at least one space is defined within the hasp assembly into which said at least one integral shackle pin protrudes, the space designed to accept at least partially the shackle-less padlock.

12. The device of claim 11, wherein two spaces are defined within the hasp assembly, wherein into each of the spaces at least one shackle pin protrudes, each of the spaces designed to accept at least partially a shackle-less padlock.

13. The device of claim 11, wherein the space is shaped to match the shape of the padlock, for enhancing gripping between the hasp elements.

14. The device of claim 9, wherein said at least one shackle pin is coupled to said hasp assembly in a manner that allows relative freedom of motion between the hasp assembly and the shackle pin.

15. The device of claim 9, wherein the two hasp elements are designed to be intertwined.

16. The device of claim 15, wherein the two hasp elements are designed to grip each other, when intertwined.

17. The device of claim 9, wherein the hasp assembly is provided with a cavity into which a pin of the shackle-less padlock may be inserted.

18. The device of claim 9, wherein said at least one integral shackle pin is detachable from the hasp assembly.

19. A locking device for locking two separate adjacent objects or immobilizing relative movement between the objects, the device comprising a hasp assembly comprising two hasp elements to be secured, to either of the objects, the hasp assembly provided with at least one protruding element on one hasp element and a matching cavity on the other hasp element, and an integral locking mechanism,
whereby when the hasp elements are brought together they intertwine and grip each other in a locked position, preventing disengagement of the two hasp elements along at least two substantially perpendicular axes, and the locking mechanism is used to lock the hasp elements and prevent disengagement.

20. The device of claim 19, wherein the hasp assembly is provided with a plurality of protruding elements on one hasp element and a plurality of matching cavities on the other hasp element.

21. The device of claim 19, wherein said at least one protruding element has a shape that is wider on a distal end and narrower on a proximal end, and wherein the matching cavity has a complementary opposite shape.

22. The device of claim 21, wherein said at least one protruding element is in the shape of a wedge.

23. The device of claim 19, wherein the locking mechanism is located in one of the hasp elements and comprising a protrusion, while the other hasp element comprises a cavity for receiving the protrusion of the locking mechanism in a locked position.
